(19) United States
(12) Patent Application Publication
(10) Pub. No.: US 2008/0203884 A1
(43) Pub. Date: Aug. 28, 2008

(54) FIELD EMISSION CATHODE AND METHOD FOR FABRICATING SAME

(75) Inventors: ZHI ZHENG, Beijing (CN); SHOU-SHAN FAN, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/774,548

(22) Filed: Jul. 6, 2007

(30) Foreign Application Priority Data
Jul. 7, 2006 (CN) 200610061573.0

(51) Int. Cl. H01J 1/304; H01J 9/02

(52) U.S. Cl. 313/309; 445/35

(57) ABSTRACT

A field emission cathode includes a substrate, a metal electrode, an aluminum transition layer, and a carbon nanotube array. The metal electrode is disposed upon the substrate. The aluminum transition layer is disposed upon the metal electrode. The carbon nanotube array is disposed upon the aluminum transition layer.

### BACKGROUND OF THE INVENTION

1. Field of the Invention

The invention relates to a field emission cathode and method for fabricating the same and, particularly, to a carbon nanotube-based field emission cathode and a method for fabricating the same.

2. Description of Related Art

Carbon nanotubes (CNTs) are a novel carbonaceous material discovered by lijima, a researcher of NEC Corporation, in 1991. Typically, carbon nanotubes have tube-shaped structures with small diameters (less than 100 nanometers) and large aspect ratios (length/diameter). They have excellent electrical properties as well as excellent mechanical properties. The electronic conductance of carbon nanotubes is related to their structures. Because the carbon nanotubes can transmit extremely high electrical current and emit electrons easily, at a low voltage of less than 100 volts, they are considered to be promising for use in a variety of display devices, such as field emission display (FED) devices.

Generally, a CNT field emission display device includes a cathode electrode and a carbon nanotube array formed on the cathode electrode. The methods adopted for forming the carbon nanotube array on the cathode electrode mainly include mechanical methods and in-situ synthesis methods. One mechanical method is performed by using an atomic force microscope (AFM) to place the synthesized carbon nanotube array on the cathode electrode and to then fix the carbon nanotube array on the cathode electrode, via a conductive paste or adhesive. The mechanical method is easy and straightforward. However, the precision and efficiency thereof are relatively low. Furthermore, the electrical connection between the cathode electrode and the carbon nanotube array tends to be poor because of the limitations of the conductive adhesives/pastes used therebetween. Thus, the field emission characteristics of the carbon nanotube array are generally unsatisfactory.

One in-situ synthesis method is performed by coating metal catalysts on the cathode electrode and directly synthesizing the carbon nanotube array on the cathode electrode, by means of chemical vapor deposition (CVD). In principle, a carbon source gas is thermally decomposed at a predetermined temperature in the presence of metal catalyst, thereby forming the carbon nanotube array. The in-situ synthesis method is relatively easy. Furthermore, the electrical connection between the cathode electrode and the carbon nanotube array is typically good because of the direct engagement therebetween.

The rear substrate where the carbon nanotube array is formed is usually made of metal materials, thus displaying good conductivity and the ability to carry high current loads. However, the metal materials are generally limited to metals such as aluminum (Al) or nickel (Ni) or alloys thereof. This limitation is necessary to prevent the material of substrate from adversely affecting formation of the carbon nanotube array. Such an adverse effect could be created by a reaction of the substrate material with the metal catalysts or by a decomposition reaction with the carbon source gas to form amorphous carbon. In addition, because the metallic substrate, such as the aluminum substrate, may be weakened due to erosion by, e.g., acid and/or alkali, it is less compatible with the micromaching techniques used in forming the cathode electrode.

What is needed, therefore, is a field emission cathode and a method for fabricating the same that can overcome the above-mentioned problems and still yield a well-aligned carbon nanotube array.

### SUMMARY OF THE INVENTION

A field emission cathode is provided. In one embodiment, the field emission cathode includes a substrate, a metal electrode, an aluminum transition layer, and a carbon nanotube array. The metal electrode is disposed directly upon the substrate. The aluminum transition layer is disposed upon the metal electrode. The carbon nanotube array is formed upon the aluminum transition layer. In this case, a thickness of the aluminum transition layer is in an approximate range from 5 nm to 40 nm.

A method for fabricating a field emission cathode is also provided. In one embodiment, the method includes the following steps: providing a substrate; forming a metal electrode on the substrate; depositing an aluminum transition layer on the metal electrode; depositing a catalyst layer on the aluminum transition layer; annealing the substrate, on which the metal electrode, the aluminum transition layer and the catalyst layer are disposed in order, the annealing being performed in air so that the catalyst layer reacts to form a plurality of oxidized catalyst particles on the aluminum transition layer; heating the treated substrate in a reactor to a first temperature in the presence of a protective gas; and introducing a mixture of a carbon source gas and a protective gas in the reactor and heating the treated substrate to a second temperature, whereby a carbon nanotube array is formed and extends from the aluminum transition layer via the oxidized catalyst particles.

Other advantages and novel features of the present field emission cathode and the method for fabricating the same will become more apparent from the following detailed description of preferred embodiments when taken in conjunction with the accompanying drawings.

### BRIEF DESCRIPTION OF THE DRAWINGS

Many aspects of the present field emission cathode and the method for fabricating the same can be better understood with reference to the following drawings. The components in the drawings are not necessarily to scale, the emphasis instead being placed upon clearly illustrating the principles of the present field emission cathode and the method for fabricating the same.

FIG. 1 is a schematic view of a field emission cathode, in accordance with a present embodiment;

FIG. 2 is a flowchart of a method for fabricating a field emission cathode, in accordance with a present embodiment;

FIG. 3 is a scanning electron microscope image of a carbon nanotube array of the field emission cathode, formed using the method in accordance with the present embodiment;

FIG. 4 is a scanning electron microscope image of another carbon nanotube array of the field emission cathode, formed using the method in accordance with the present embodiment; and

FIG. 5 is a scanning electron microscope image of a carbon nanotube array of a field emission cathode, formed using a conventional method for fabricating the same.

Corresponding reference characters indicate corresponding parts throughout the several views. The exemplifications set out herein illustrate at least one preferred embodiment of the present field emission cathode and the method for fabricating the same, in one form, and such exemplifications are not to be construed as limiting the scope of the invention in any manner.

### DETAILED DESCRIPTION OF THE INVENTION

Reference will now be made to the drawings to describe embodiments of the present field emission cathode and method for fabricating the same, in detail.

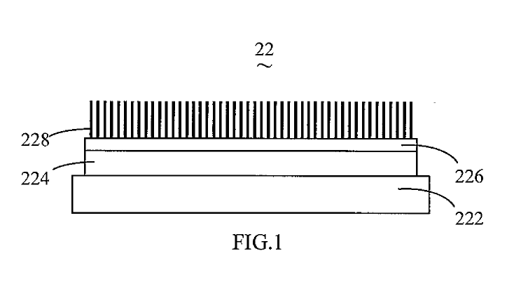

Referring to FIG. 1, a field emission cathode 22, according to a present embodiment, is shown. The field emission cathode 22 includes a substrate 222, a metal electrode 224, an aluminum transition layer 226, and a carbon nanotube array 228. The metal electrode 224 is disposed directly upon the substrate 222. The aluminum transition layer 226 is disposed upon the metal electrode 224. The carbon nanotube array 228 is formed upon the aluminum transition layer 226.

In the present embodiment, the substrate 222 is composed of, for example, silicon or silicon dioxide (SiO₂). Thus, this nonmetallic substrate 222 can act as a supporter to allow the field emission display device using the substrate 222 to have a higher resolution and to be capable of forming an addressing matrix.

The metal electrode 224 has a thickness in an approximate range from 60 nm to 200 nm and is made of gold (Au), silver (Ag), copper (Cu), or molybdenum (Mo), or of alloys incorporating such metals. Usefully, the metal electrode 224 is made of molybdenum, which has the merits, at least, of a high melting point and significant corrosion resistance, in particular, against hydrogen fluoride (HF), so as to have better compatibility with the micromaching techniques often used in forming a triode field emission display device.

The aluminum transition layer 226 has a thickness in an approximate range from 5 nm to 40 nm. More suitably, the thickness of the aluminum transition layer 226 is about 40 nm. The carbon nanotube array 228 includes a plurality of well-aligned carbon nanotubes. The carbon nanotubes have an average diameter in an approximate range from 5 nm to 20 nm and have an average length in an approximate range from 2 nm to 20 nm. By disposing the aluminum transition layer 226 between the metal electrode 224 and the carbon nanotube array 228, the electric resistance therebetween is effectively minimized, and, as such, the field emission display device has a great capacity for the field emission.

Additionally, a method for fabricating the field emission cathode, according to a present embodiment, includes the following steps:
providing a substrate (step 1);
forming a metal electrode directly on the substrate (step 2);
depositing an aluminum transition layer on and in contact with the metal electrode (step 3);
depositing a catalyst layer directly on the aluminum transition layer (step 4);
annealing the substrate, on which the metal electrode, the aluminum transition layer, and the catalyst layer are disposed in order, so that the catalyst layer reacts to form a plurality of oxidized catalyst particles (step 5);
heating the treated substrate in a reactor to a first predetermined temperature in the presence of a protective gas (step 6); and
introducing a mixture of a carbon source gas and the protective gas in the reactor and heating the treated substrate to a second predetermined temperature (i.e., a reaction temperature), such that a carbon nanotube array is formed thereon and extends from the aluminum transition layer, via the oxidized catalyst particles (step 7).

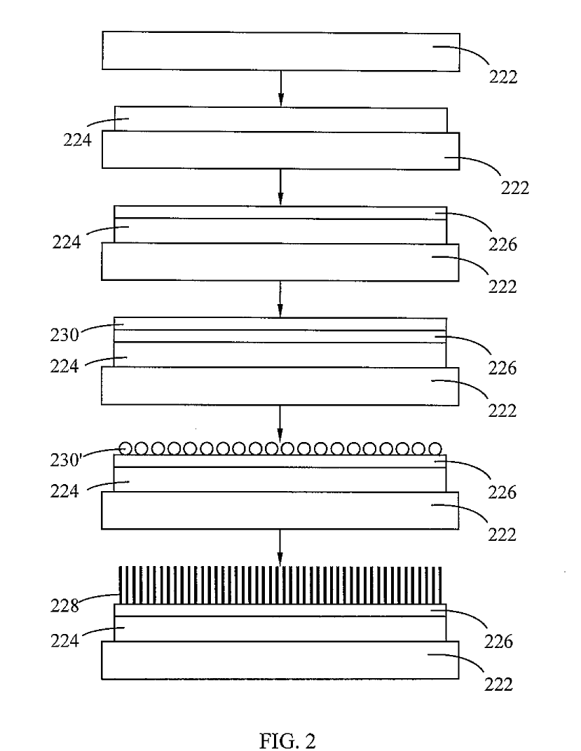

Each step of the present method is described in more detailed below, with reference to FIG. 2.

Step 1 provides the substrate 222 advantageously made of silicon, silicon dioxide, or mixture/compound including such materials. That is, the substrate 222 in the present embodiment can be a silicon substrate, a quartz substrate, or a glass substrate.

Step 2 forms the metal electrode 224, having a thickness in an approximate range from 60 nm to 200 nm on the substrate 222. In the present embodiment, the metal electrode 224 can, advantageously, be made of a high-conductivity, corrosion-resistance metal/alloy, such as Au, Ag, Cu, or Mo, or an alloy thereof. The metal electrode 224 is formed on one surface of the substrate 222 by, e.g., photolithography, electron beam lithography in cooperation with reactive ion etching, dry etching, or wet etching. However, the way of forming the metal electrode 224 is not limited to what is mentioned above.

In Step 3, the aluminum transition layer 226 is deposited at a thickness in an approximate range from 5 nm to 40 nm directly on the metal electrode 224. In the present embodiment, the aluminum transition layer 226 is formed, for example, by evaporating or sputtering to have a thickness of about 40 nm.

Step 4 involves depositing the catalyst layer 230, having a thickness in an approximate range from 3 nm to 10 nm, on the aluminum transition layer 226. In the present embodiment, the catalyst layer 230 includes a catalyst material, beneficially selected from the group consisting of iron (Fe), cobalt (Co), nickel (Ni), and an alloy thereof. It is noted that the thickness of catalyst layer 230 is usually chosen corresponding to the type of catalyst selected. For example, when the catalyst layer 230 is made of iron, the thickness of iron catalyst layer 230 is in the approximate range from 3 nm to 10 nm and most suitably is about 5 nm.

At Step 5, the substrate 222, with the metal electrode 224, the aluminum transition layer 226, and the catalyst layer 230 disposed in order thereon, is annealed. In this step, the treated substrate is first placed in the air and then is treated by heating to a temperature substantially in an approximate range from 300° C. to 500° C. for about 10 minutes to 12 hours, with a shorter anneal time usually needed at a higher treatment temperature. As a result, the catalyst layer 230 is oxidized, thereby yielding a plurality of oxidized catalyst particles 230′ directly on the aluminum transition layer 226.

Step 6 provides for the heating of the treated substrate in a manner to form a carbon nanotube array 228. In this step, the treated substrate is placed in a reactor suitable to perform the chemical vapor deposition (CVD). Then, a protective gas is introduced into the reactor. The treated substrate is preheated to the first predetermined temperature, in the presence of the protective gas in order to prevent further oxidizing the oxidized catalyst particles 230′, as such over-oxidation could adversely affect formation of the carbon nanotube array 228. In the present embodiment, the protective gas is, usefully, an inert gas and/or nitrogen gas. Most suitably, the protective gas is argon. The first predetermined temperature is generally in an approximate range from 400° C. to 750° C. and depends on which catalyst is selected. For example, when the catalyst layer 230 is made of iron, the first predetermined temperature is preferably 650° C.

Step 7 involves introducing a mixture gas and heating the treated substrate for growing the carbon nanotube array 228. In the present embodiment, the mixture gas, composed of the carbon source gas and the protective gas, is introduced into the reactor, and the treated substrate is heated to the second predetermined temperature, substantially in an approximate range from 400° C. to 750° C. for about 0.5 minutes to 2 hours. As the result, the oxidized catalyst particles 230′ are reduced into nano-sized catalyst particles by decomposing the carbon source gas. Furthermore, the carbon nanotube array 228 is formed and extends from the aluminum transition layer 226, and then the field emission cathode 22 is formed finally. In the present embodiment, the carbon source gas can, advantageously, be a hydrocarbon, such as acetylene or ethylene. Quite usefully, the carbon source gas is acetylene. As mentioned above, the protective gas in this step can be an inert gas or nitrogen gas. Rather opportunely, the protective gas is argon.

In addition, before the step 7, the method in the present embodiment can further include a step of introducing hydrogen gas (H₂) or ammonia gas (NH₃) to reduce the oxidized catalyst particles 230′ into nano-sized catalyst particles. However, this step is not necessary, in practice, to achieve forming of the field emission cathode.

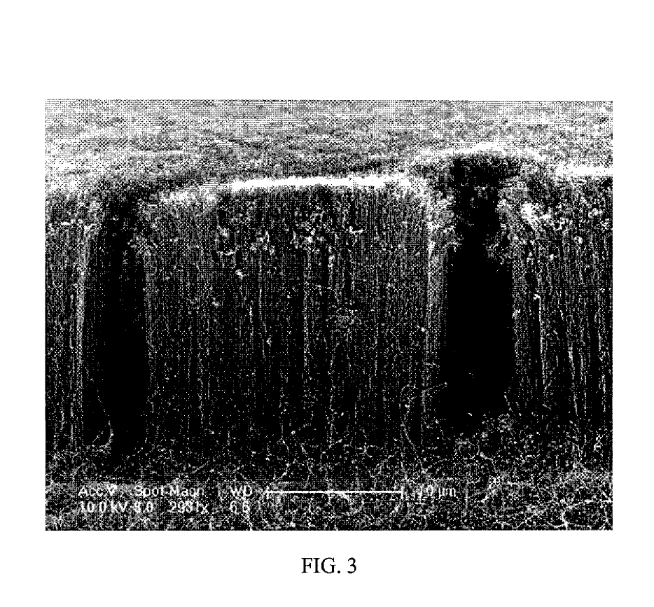

Referring to FIG. 3, a scanning electron microscope (SEM) image of the carbon nanotube array, formed by the method for fabricating the field emission cathode according to the present embodiment, is shown. As shown in FIG. 3, the carbon nanotubes have an average diameter in an approximate range from 5 nm to 20 nm and an average length in an approximate range from 2 nm to 20 nm.

In the particular present embodiment, resulting the device illustrated in FIG. 3, the method includes the following steps:
providing a substrate made of silicon dioxide;
sputtering a molybdenum layer at a thickness of about 100 nm directly on the substrate and then forming a molybdenum electrode by wet etching;
sputtering an aluminum transition layer at a thickness of about 37 nm on and in contact with the molybdenum electrode;
sputtering an iron catalyst layer at a thickness of about 5 nm directly on the aluminum transition layer;
placing the substrate, on which the molybdenum electrode, the aluminum transition layer, and the iron catalyst layer are deposited/coated, in air and then heating the as-coated substrate to a temperature about 300° C. for 10 minutes, so that the iron catalyst layer is annealed to form a plurality of oxidized iron particles;
placing the treated substrate with the oxidized iron particles thereon in the quartz reactor and heating the treated substrate to a temperature about 650° C. in the presence of argon;
introducing hydrogen gas to reduce the oxidized iron particles into nano-sized iron particles on the aluminum transition layer; and
introducing a mixture of acetylene and argon and then heating the treated substrate to a temperature about 700° C. for 20 minutes, so that the carbon nanotube array is formed and extends from the aluminum transition layer, each carbon nanotube in the array respectively extending from a site of a corresponding nano-sized iron particle on the aluminum transition layer.

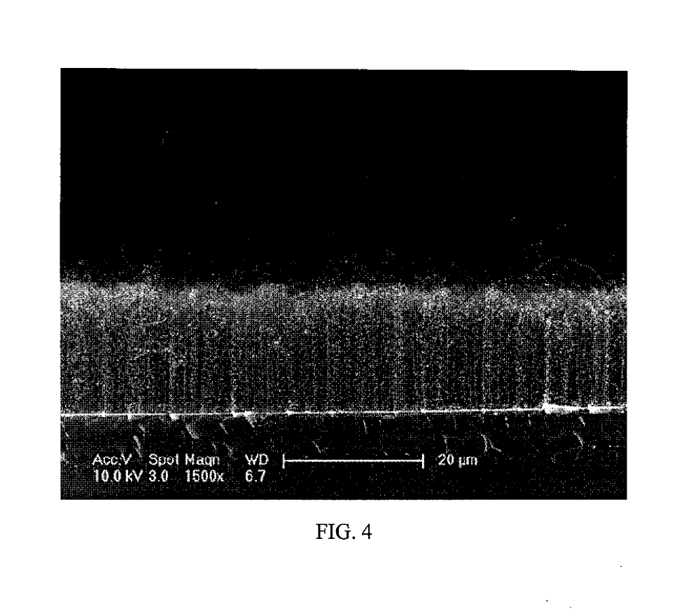

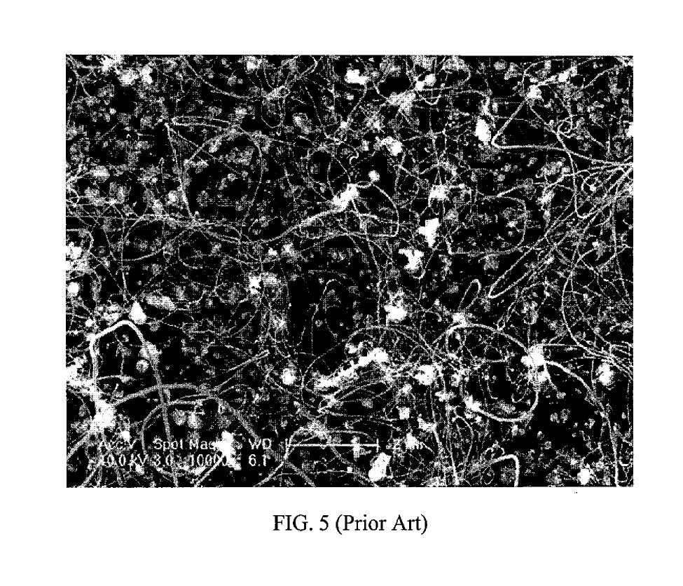

Referring to FIG. 4, a SEM image of another carbon nanotube array, formed by another particular application of the present method for fabricating a field emission cathode, is shown. As shown in FIG. 5, the carbon nanotubes of the carbon nanotube array has an average diameter in an approximate range from 5 nm to 20 nm and an average length in an approximate range from 2 nm to 20 nm.

In the present embodiment, the method includes the following steps:
providing a silicon substrate;
sputtering a molybdenum layer at a thickness of about 176 nm on the silicon substrate and then forming a molybdenum electrode by wet etching;
sputtering an aluminum transition layer at a thickness of about 40 nm on the molybdenum electrode;
sputtering an iron catalyst layer at a thickness of about 5 nm upon the aluminum transition layer;
placing the substrate, on which the molybdenum electrode, the aluminum transition layer and the iron layer are deposited in order, in air and then heating the as-layered substrate to a temperature about 300° C. for 10 minutes so that the iron catalyst layer is annealed into a plurality of oxidized iron particles;
placing the treated substrate with the oxidized iron particles thereon in the quartz reactor and heating such to a temperature about 650° C. in the presence of argon;
introducing hydrogen gas to reduce the oxidized iron particles into nano-sized iron particles on the aluminum transition layer; and
introducing a mixture of acetylene and argon and then heating the treated substrate to a temperature about 700° C. for 20 minutes so that the carbon nanotube array is formed and extends from the aluminum transition layer, via the nano-sized iron particles.

Referring to FIG. 5, a comparable SEM image of the carbon nanotube array, formed by a conventional method for fabricating a field emission cathode, is shown. Comparing with FIG. 3, FIG. 4 and FIG. 5, the carbon nanotubes of field emission cathode formed by the general method according to the present embodiment are aligned uniformly and have a preferred orientation (i.e., well-aligned, closely packed in array groupings, and approximately perpendicular to the substrate and the aluminum transition layer), while those nanotubes formed by the conventional method are aligned sparsely and are not well-oriented.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A field emission cathode, comprising:
a substrate;
a metal electrode disposed upon the substrate;
an aluminum transition layer disposed upon the metal electrode; and
a carbon nanotube array formed upon the aluminum transition layer.

2. The field emission cathode as claimed in claim 1, wherein a thickness of the aluminum transition layer is in an approximate range from 5 nm to 40 nm.

3. The field emission cathode as claimed in claim 1, wherein the substrate is comprised of at least one of silicon and silicon dioxide.

4. The field emission cathode as claimed in claim 1, wherein the metal electrode is comprised of molybdenum, and the metal electrode has a thickness in an approximate range from 60 nm to 200 nm.

5. The field emission cathode as claimed in claim 1, wherein the carbon nanotube array is comprised of a plurality of carbon nanotubes, the carbon nanotubes have an average diameter in an approximate range from 5 nm to 20 nm and have an average length in an approximate range from 2 nm to 20 nm.

6. A method for fabricating a field emission cathode, the method comprising the steps of:
providing a substrate;
forming a metal electrode on the substrate;
depositing an aluminum transition layer on the metal electrode;
depositing a catalyst layer on the aluminum transition layer;
annealing the substrate, on which the metal electrode, the aluminum transition layer, and the catalyst layer are disposed in order, the annealing being performed in air so that the catalyst layer reacts to form a plurality of oxidized catalyst particles;
heating the treated substrate in a reactor to a first temperature in the presence of a protective gas; and
introducing a mixture of a carbon source gas and the protective gas in the reactor and heating the treated substrate to a second temperature, whereby a carbon nanotube array is formed and extends from the aluminum transition layer.

7. The method as claimed in claim 6, wherein the substrate is a silicon substrate, a quartz substrate, or a glass substrate.

8. The method as claimed in claim 6, wherein the metal electrode is formed on the substrate by at least one of photolithography, electron beam lithography, reactive ion etching, dry etching, and wet etching.

9. The method as claimed in claim 6, wherein the metal electrode is comprised of molybdenum and has a thickness in an approximate range from 60 nm to 200 nm.

10. The method as claimed in claim 6, wherein the aluminum transition layer is disposed on the metal electrode by evaporating or sputtering.

11. The method as claimed in claim 6, wherein a thickness of the aluminum transition layer is in an approximate range from 5 nm to 40 nm.

12. The method as claimed in claim 6, wherein a thickness of the catalyst layer is in an approximate range from 3 nm to 10 nm.

13. The method as claimed in claim 6, wherein the treated substrate is annealed by heating to a temperature in an approximate range from 300° C. to 500° C. for about 10 minutes to 12 hours.

14. The method as claimed in claim 6, wherein the first temperature is in an approximate range from 400° C. to 750° C.

15. The method as claimed in claim 6, wherein the second temperature is in an approximate range from 400° C. to 750° C., and the treated substrate is heated to the second temperature for about 0.5 minutes to 2 hours.

16. The method as claimed in claim 6, further comprising the following step before the step of introducing the mixture of the carbon source gas and the protective gas:
introducing hydrogen gas or ammonia gas to reduce the oxidized catalyst particles into nano-sized catalyst particles.

17. The method as claimed in claim 6, wherein the catalyst comprises at least one material selected from the group consisting of iron, cobalt, nickel, and alloys thereof.
